(19) United States
(12) Patent Application Publication
(10) Pub. No.: US 2006/0075552 A1
(43) Pub. Date: Apr. 13, 2006

(54) Invalid hoist with safety device

(76) Inventor: Mark Diggins, Bridgend (GB)

Correspondence Address: JOEL D. SKINNER, JR.;SKINNER AND ASSOCIATES, 212 COMMERCIAL ST., HUDSON, WI, 54016, US

(21) Appl. No.: 11/246,335

(22) Filed: Oct. 7, 2005

(30) Foreign Application Priority Data
Oct. 7, 2004 (GB) 0422237.8

(51) Int. Cl. A61G 7/14

(52) U.S. Cl. 5/81.1 R

(57) ABSTRACT

An invalid hoist comprises a support member 10, a bar 12 pivotally connected to the support member 10, drive means for driving the bar 12 for pivotal movement relative to the support member 10 and damper means 18, independent of the drive means, for damping movement of the arm 12 relative to the support member 10.

This invention relates to a safety device for incorporation into an invalid hoist, and to an invalid hoist incorporating such a device.

Invalid hoists are commonly used to lift, for example, the elderly or disabled, for example to assist in moving an individual from a bed or chair to a wheelchair. The use of hoists in these applications is becoming increasingly common as it reduces the risk of injury to a carer who would otherwise be manually lifting and moving the patient. It may also reduce the number of carers required to be present to perform such tasks.

A typical hoist design includes an upright mounted upon legs, the legs typically being provided with wheels or castors. Pivotally connected to the upper end of the upright is a bar designed to carry a sling. A drive arrangement, for example of linear motor or hydraulic form, is connected between the upright and the bar to drive the bar for pivotal movement relative to the upright. Some designs of hoist further include a foot plate upon which a user places his feet, and a knee pad against which his knees abut, however designs are also common in which these features are not present.

There is a risk, with such a hoist, that failure of the drive arrangement may allow the bar to fall under the action of gravity. In such circumstances, there is a significant risk of injury to a user being lifted, either resulting from the bar striking the user or from the user being allowed to fall to the floor or onto another object. There is further a risk of injury to a carer operating the hoist. It is an object of the invention to provide a hoist in which the risk of such injury is reduced.

According to the present invention there is provided an invalid hoist comprising a support member, a bar pivotally connected to the support member, drive means for driving the bar for pivotal movement relative to the support member and damper means, independent of the drive means, for damping movement of the arm relative to the support member.

In the event of failure of the drive means, in such an arrangement, movement of the arm is damped by the damper means with the result that the risk of injury of a user or of a carer or other persons close to the hoist is reduced. The damper means still allows the arm to lower under the action of gravity, but the lowering of the arm occurs in a more controlled manner.

The damper means conveniently comprises a housing connected to one of the support member and the bar, a rod connected to the other of the support member and the bar, the rod extending into the housing and being connected to a moveable partition which divides the housing into two chambers. Conveniently, a restricted flow path is provided to allow fluid to flow, at a restricted rate, between the chambers. The fluid may be either gas, for example air, or liquid. The restricted flow path conveniently comprises one or more small openings provided in the partition. Alternatively, the flow path could be defined by pipes or the like located externally of the housing.

The invention will further be described, by way of example with reference to the accompanying drawings, in which:

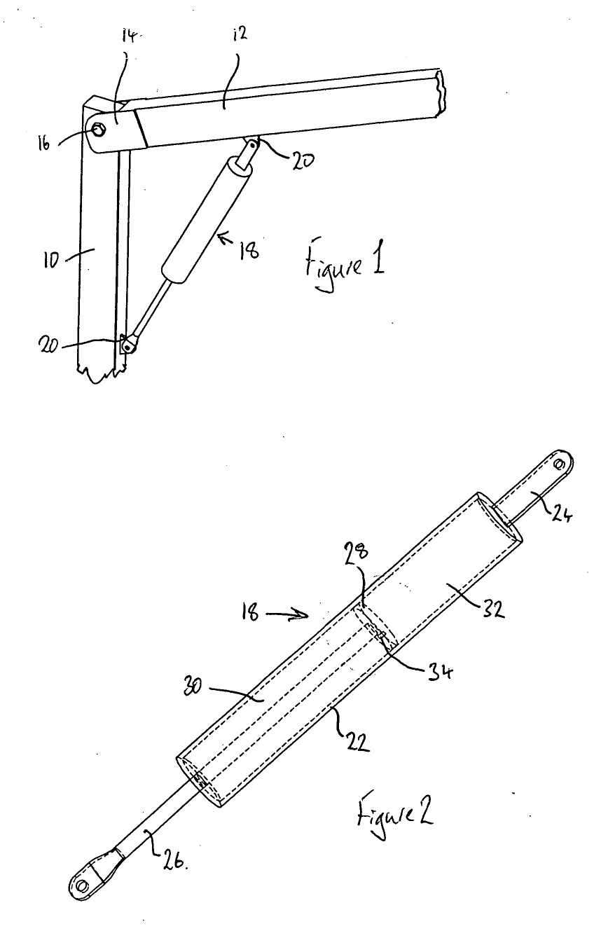

FIG. 1 is a diagrammatic view illustrating part of hoist;

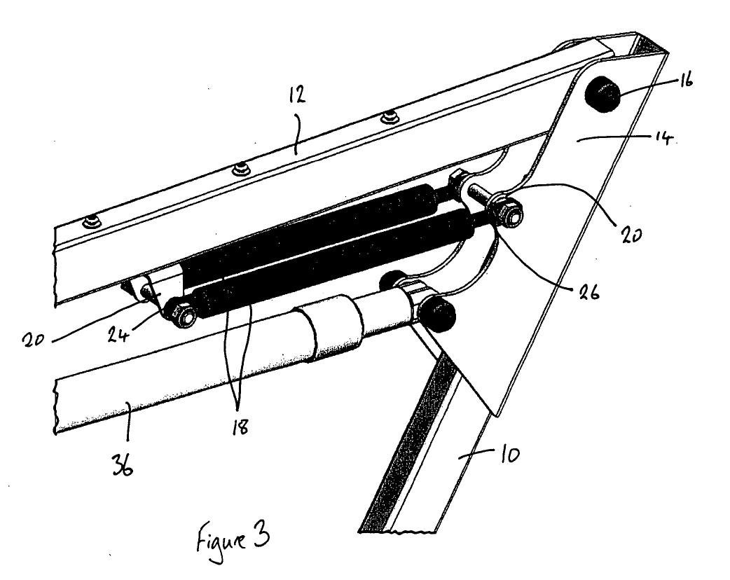

FIG. 2 is a diagrammatic view of the damper means of the hoist of FIG. 1; and

FIG. 3 is a view illustrating an alternative embodiment.

FIG. 1 illustrates part of an invalid hoist comprising an upright or mast 10 to the upper end of which is pivotally mounted a bar 12. The pivotal mounting between the upright 10 and the bar 12 may take a range of forms. In the illustrated arrangement, it takes the very simple form of providing the bar 12 with a forked end region 14, a bolt 16 passing through openings formed in the forked end region 14 and in the upper part of the upright 10.

The upright 10 is supported upon a pair of generally horizontally extending legs (not shown), the legs being provided with wheels or castors to assist in movement of the hoist over the ground. The hoist may further include a foot plate upon which a user's feet are placed, in use, and a knee engagement pad. However, a number of hoist designs are known in which these features are not present. The nature of such components may be conventional and so they are not described further and are not illustrated in the accompanying drawings.

The bar 12 is provided, at its end remote from its pivotal connection to the upright 10, with formations to allow it to be used in the lifting of a user. Such formations may be designed to allow a sling or other device to be suspended form the bar 12. However, arrangements are also possible in which the use of a sling may be avoided and instead the bar be connected to, for example, supports intended to be located, in use, beneath the user's arms.

A drive means (not shown) is provided to drive the bar 12 for pivotal movement relative to the upright 10. The drive means could take a range of forms. For example, it could take the form of a linear motor. As the precise nature of the drive means is not relevant to the invention, it is not described further herein.

A damper 18 is connected between the upright 10 and the bar 12. As illustrated, the upright 10 and the bar 12 are both provided with support mountings 20 to which the damper 18 is pivotally connected. The damper comprises a cylindrical housing 22 from one end of which extends a projection 24 intended to be pivotally mounted to one of the support mountings 20. The opposing end of the housing 22 is provided with an opening through which extends a rod 26. Suitable seal means are provided between the housing 22 and the rod 26 to substantially prevent the escape of fluid from the interior of the housing 22. Within the housing 22, the rod 26 carries a partition member 28 in the form of a disc adapted to form a substantially fluid-tight seal with the interior of the housing 22 so as to divide the interior of the housing into two independent chambers 30,32. The end of the rod 26 remote from the partition member 28 is adapted to be pivotally mounted to the other of the support mountings 20.

As illustrated in FIG. 2, a restricted fluid path is provided between the chambers 30, 32. The restricted fluid path takes the form of a small diameter opening 34 provided in the partition member 28 to allow fluid to flow at a restricted rate between the chambers 30, 32.

In use, when the drive means is being used to move the arm 12 relative to the upright 10, to lift the arm 12, the rod 26 must be gradually withdrawn from the housing 22, and in order to achieve this, fluid must flow from the chamber 30 to the chamber 32 through the restricted fluid path. As the restricted fluid path restricts the rate at which fluid can move from the chamber 30 to the chamber 32, it will be understood that the rate at which the rod 26 can be withdrawn from the housing 22, and hence the rate at which the bar 12 can be lifted, is restricted. However, the size of the opening 34 forming the restricted flow path is chosen so as not to unduly increase the load on the drive means during normal lifting movement of the arm 12.

Similarly, in normal use, lowering of the arm 12 using the drive means requires the rod 26 to be pushed into the housing, requiring fluid to flow from the chamber 32 through the opening 34 to the chamber 30.

In the event of the failure of the drive means, a large part of the load being carried by the arm 12 may be transmitted to the upright 10 through the damper 18. In the absence of the damper 18, the arm 12 would fall under the action of gravity and there would be the risk that a user supported by the arm 12 could fall to the ground and be injured. There is further the risk that the arm 12 may impact upon either the user, a carer operating the hoist, or another individual in the vicinity of the hoist. By providing the damper 18 lowering of the arm 12 under such circumstances occurs at a controlled rate, the rate at which the arm 12 is lowered being governed by the damper 18.

In order for the arm 12 to lower, under such circumstances, the rod 26 must be pushed further into the housing 22, and such movement must be accompanied by fluid flowing from the chamber 32 to the chamber 30 through the opening 34. As the opening 34 only permits fluid to flow at a restricted rate, it will be appreciated that the damper 18 serves to limit the rate at which the arm 12 is lowered. Clearly, by limiting the rate at which the arm is lowered, the risk of injury to a user, carer or other individual in the vicinity of the hoist is reduced.

The fluid contained within the damper 18 could take the form of either a gas or a liquid. Although the illustrated embodiment includes only a single flow path through the partition member 28, it will be appreciated one or more additional flow paths may be provided in the partition member 28, if desired, the combined restriction to flow formed by all of the openings being chosen to allow the operation of the damper 18 to restrict movement of the arm 12 to the desired rate.

A range of other modifications or alterations may be made to the device illustrated and described herein. For example, rather than provide a flow path through the partition member 28, a restricted flow path maybe provided externally of the housing 22 by using pipes or passages interconnecting the chambers 30, 32, the pipes or passages being of diameter chosen to limit the rate at which fluid can flow between the chambers to the desired rate.

Although the illustrated embodiment shows the damper 18 orientated such that the housing 22 is connected to the arm 12 and the rod 26 is connected to the upright 10, it will be appreciated that this orientation may be reversed, if desired.

A number of other modifications or alterations are possible within the scope of the invention. For example, FIG. 3 illustrates an arrangement in which two dampers 18 are provided side-by-side, both being arranged to damp movement of the arm 12 in the event of the failure of the drive means (part of which is shown in FIG. 3 denoted by reference numeral 36).

1. An invalid hoist comprising a support member, a bar pivotally connected to the support member, drive means for driving the bar for pivotal movement relative to the support member and damper means, independent of the drive means, for damping movement of the arm relative to the support member.

2. A hoist according to claim 1, wherein the damper means comprises a housing connected to one of the support member and the bar, and a rod connected to the other of the support member and the bar, the rod extending into the housing and being connected to a moveable partition which divides the housing into two chambers.

3. A hoist according to claim 2, further comprising a restrict flow path to allow fluid to flow, at a restricted rate, between the chambers.

4. A hoist according to claim 3, wherein the restricted flow path is defined by at least one small opening provided in the partition.

5. A hoist according to claim 1, further comprising at least a second damper means located adjacent the said damper means.
